(19) United States
(12) Patent Application Publication
(10) Pub. No.: US 2008/0193788 A1
(43) Pub. Date: Aug. 14, 2008

(54) Heat insulating material and method for producing the same

(75) Inventor: Shigeru Nakama, Hamamatsu-shi (JP)

Correspondence Address: NIXON & VANDERHYE, PC, 901 NORTH GLEBE ROAD, 11TH FLOOR, ARLINGTON, VA, 22203, US

(73) Assignee: NICHIAS CORPORATION, Tokyo (JP)

(21) Appl. No.: 12/068,958

(22) Filed: Feb. 13, 2008

(30) Foreign Application Priority Data
Feb. 14, 2007 (JP) 2007-33484

(51) Int. Cl. B32B 7/12; B32B 5/18; B32B 37/12; B32B 27/12

(52) U.S. Cl. 428/550; 428/317.7; 442/136; 156/284

(57) ABSTRACT

The present invention provides a heat insulating material comprising a heat insulating formed body and a sheet-shaped porous material bonded to at least a part of the surface of the heat insulating formed body with a binder, wherein the binder comprises: inorganic particles having an average particle size of 0.05 to 50 μm; and at least one of a hydrolysate of a metal alkoxide compound and a sol of a metal oxide. Also, a method for producing the heat insulating material is disclosed.

### FIELD OF THE INVENTION

The present invention relates to a heat insulating material covered with a sheet-shaped porous material and a method for producing the same.

### BACKGROUND OF THE INVENTION

Recently, there have been widely used heat insulating materials obtained by press forming of fine inorganic particles such as fumed silica and alumina, and heat insulating materials obtained by press forming of compositions in which fibrous materials for reinforcement or opacifying agents for inhibiting transmission of radiation light to improve a heat insulating effect are blended with fine inorganic particles, because of their excellent heat insulating properties. However, such heat insulating materials containing fine inorganic particles are very brittle, so that they involve a problem of being broken down by a slight impact during carrying or undertaking construction. Further, they also involve a problem of frequent occurrence of attachment of fine inorganic particles to the hand or dressing of workers who treat them.

Furthermore, heat insulating materials free from fine inorganic particles also break during carrying or undertaking construction in some cases.

From such a background, for the purpose of reinforcing the heat insulating materials themselves and preventing the adhesion of the fine inorganic particles, it has been generally conducted to cover the overall surfaces of the heat insulating materials with metal films, plastic films, woven fabrics made of glass fiber, or the like. However, when cutting or hole-making processing is applied to the heat insulating materials, there is a disadvantage of impairing the intended effect or, depending on the kind of covering material, a disadvantage of restricting the working temperature.

Further, it has also been conducted to enhance adhesion between the heat insulating materials and the covering materials with organic binders or inorganic binders (for example, see patent document 1). However, the organic binders give a restriction to the working temperature of the heat insulating materials. The inorganic binders decrease the restriction to the working temperature of the heat insulating materials, but are insufficient in adhesive force, which poses a problem of frequent occurrence of separation of the covering materials during carrying the heat insulating materials. Furthermore, the organic binders and the inorganic binders have been applied as aqueous solutions. When a highly polar liquid such as water is used, the fine particles on, a surface of the heat insulating material rapidly coagulate, resulting in the occurrence of deformation such as cracks and depressions. It is therefore necessary to extremely strictly control the water amount of the aqueous binder solution and the coating amount thereof, which is presumed to be not suitable for industrial applications.

Patent Document 1: JP-A-2005-36975

### SUMMARY OF THE INVENTION

The invention has been made in view of the foregoing circumstances. In a heat insulating material covered with a covering material in order to prevent breakage during carrying or processing and to prevent attachment of fine inorganic particles, it is an object of the invention to remove a restriction of the working temperature, increase the adhesive strength of the covering material, and further relax manufacturing conditions to enhance productivity.

In order to achieve the above-mentioned object, the invention provides the following heat insulating materials and methods for producing the same.

(1) A heat insulating material comprising a heat insulating formed body and a sheet-shaped porous material bonded to at least a part of the surface of the heat insulating formed body with a binder, wherein the binder comprises:

inorganic particles having an average particle size of 0.05 to 50 μm; and

at least one of a hydrolysate of a metal alkoxide compound and a sol of a metal oxide;

(2) The heat insulating material described in the above (1), wherein the heat insulating formed body contains fine silica particles, fine alumina particles, fine aluminum silicate particles or a mixture thereof, which has a BET specific surface area of 15 to 500 m²/g and a primary particle size of 0.003 to 1 μm;

(3) The heat insulating material described in the above (1) or (2), wherein the heat insulating formed body contains at least one of a fibrous material and an opacifying material;

(4) The heat insulating material described in any one of the above (1) to (3), wherein the porous material is a papermaking product, a woven fabric or a nonwoven fabric, which contain an inorganic fibrous material;

(5) A method for producing a heat insulating material which comprises bonding a heat insulating formed body and a sheet-shaped porous material to each other with a slurry adhesive containing:

inorganic particles having an average particle size of 0.05 to 50 μm;

at least one of a metal alkoxide compound and a sol of a metal oxide; and

a solvent;

(6) The method for producing a heat insulating material described in the above (5), wherein the method comprises:

superimposing the heat insulating formed body and the porous material one on the other;

applying the adhesive onto the porous material to allow the adhesive to penetrate thereinto; and

drying;

(7) The method for producing a heat insulating material described in the above (5) or (6), wherein the solvent is a mixed solution of water and an alcohol having a water/alcohol weight ratio ranging from 0/100 to 70/30; and

(8) The method for producing a heat insulating material described in any one of the above (5) to (7), wherein the adhesive contains an organic thickening agent.

In the heat insulating material of the invention, a heat insulating formed body and a sheet-shaped porous material are firmly bonded to each other with a binder containing inorganic particles and at least one of a hydrolysate of a metal alkoxide compound and a sol of a metal oxide, so that the reinforcing effect is high, and the handling ability is good. Further, the binder is composed of only inorganic materials, and the porous material having heat insulating properties equivalent to or higher than the heat insulating formed body is used, thereby imposing no restriction on the working temperature of the heat insulating material. Furthermore, the adhesive also has a wide allowable range of the water amount, which can relax the manufacturing conditions.

### BRIEF DESCRIPTION OF THE DRAWING

FIGS. 1(A) to 1(D) are schematic views showing one embodiment of a method for producing a heat insulating material of the invention.

The reference numerals in the drawing denote the following, respectively.
1: Heat insulating formed body
2: Porous material
3: Adhesive
4: Brush
5: Roller
6: Air
7: Portion of heat insulating formed body into which adhesive penetrates

### DETAILED DESCRIPTION OF THE INVENTION

The invention will be described in detail below.

The heat insulating material of the invention comprises a heat insulating formed body and a sheet-shaped porous material bonded to each other. Although there is no particular limitation on the heat insulating formed body, it is preferred to contain fine inorganic particles from the aspect of heat insulating performance.

Specifically, the heat insulating formed body preferably contains fine silica particles, fine alumina particles, fine aluminum silicate particles or a mixture thereof, which have a BET specific surface area of 15 to 500 m²/g and a primary particle size of 0.003 to 1 μm, as a main component. When the primary particle size of the fine inorganic particles exceeds 1 μm, the heat insulating formed body cannot have a sufficient heat insulating effect. On the other hand, less than 0.003 μm results in considerably high bulkiness to make handling difficult. Further, when the BET specific surface is less than 15 m²/g or exceeds 500 m²/g, the heat insulating formed body cannot have a sufficient heat insulating effect.

Such materials include silica obtained by burning of a halide or the like, silica obtained by the reaction of sodium silicate and sulfuric acid, silica obtained by the condensation of an alkoxide, alumina produced by similar methods and aluminum silicate.

Although the heat insulating formed body may be formed of only the above-mentioned fine inorganic particles, it may further contain a fibrous material for reinforcement. The fibrous materials include inorganic fibers such as glass fiber, alumina fiber, mullite fiber, silica fiber, aluminum silicate fiber, silicate fiber, aluminosilicate fiber, carbon fiber and silicon carbide fiber, organic fibers such as polyethylene fiber, polypropylene fiber and polyaramid fiber, and mixtures thereof. These materials are appropriately selected considering an atmosphere, temperature and the like where the heat insulating material is to be used. There is no limitation on the fiber diameter and the fiber length. It is suitable that the fiber diameter is from 0.8 to 50 μm and that the fiber length is from 1 to 15 mm, although they depend on the kind of fiber.

Further, the heat insulating formed body may contain an opacifying material. The opacifying material has a function of inhibiting transmission of radiation light, and has an effect of enhancing heat insulating performance. The opacifying materials include titanium oxide, zirconium oxide, zirconium silicate, silicon carbide, zinc oxide, iron oxide, ilmenite and mixtures thereof. From these, a suitable one may be selected considering an opacifying effect at a temperature at which the heat insulating material is used, and the like.

When the fibrous material and the opacifying material are contained, it is suitable that the content of the fibrous material is adjusted to 30% by mass or less based on the total amount of the heat insulating formed body and that the content of the opacifying material is adjusted to 50% by mass or less on the total amount of the heat insulating formed body. When the content of the fibrous material exceeds 30% by mass, the influence of the heat insulating formed body on heat insulating properties increases, resulting in a failure to obtain a sufficient heat insulating effect. Further, when the content of the opacifying material exceeds 50% by mass, the thermal conductivity of the opacifying material itself becomes higher than the effect of inhibiting transmission of radiation light, also resulting in a failure to obtain a sufficient heat insulating effect.

The heat insulating formed body is obtained by placing the fine inorganic particles or a mixture of the fine inorganic particles and the fibrous material or opacifying material added as needed in a specified mold, and applying pressure thereon. Forming conditions are appropriately set depending on the kind of fine inorganic particles, the kind of fibrous material or opacifying material and the blending ratio thereof, the form of the formed body to be obtained, and the like.

In addition, although there is no particular limitation on the density of the heat insulating formed body, it is preferably from 150 to 600 kg/m³, and more preferably from 200 to 400 kg/m³, from the viewpoint of exhibiting heat insulating performance. Further, although there is also no particular limitation on the thermal conductivity, it is preferably from 0.020 to 0.050 W/m·K (100° C.), from the viewpoint of exhibiting heat insulating performance.

As the sheet-shaped porous material, there is used a product obtained by a papermaking machine/method (hereinafter referred to as a “papermaking product”), a woven fabric or a nonwoven fabric, which contains an inorganic fibrous material, from the viewpoint of heat insulating properties. The inorganic fibrous materials include glass fiber, alumina fiber, mullite fiber, silica fiber, aluminum silicate fiber, carbon fiber, silicon carbide fiber, basalt fiber, rock wool fiber and mixtures thereof. These materials are appropriately selected considering an atmosphere, temperature and the like where the heat insulating material is to be used. Further, although there is also no particular limitation on the thickness and the weight per unit area of the porous material, these may be appropriately set considering the strength required for the heat insulating material, the thermal expansion coefficient at the working temperature, and the like. In general, the porous material having a thickness of 0.05 to 3 mm and a weight per unit area of 50 to 800 g/m² can be used.

A sheet-shaped material which is not porous generally has a high thermal expansion coefficient, so that it has a high possibility of separation at the time of use, even when bonded with an adhesive. Further, a sheet-shaped material composed of an organic fibrous material imposes a large restriction on the working temperature of the heat insulating material to be obtained, resulting in impairment of the effectiveness of the invention.

The above-mentioned heat insulating formed body and porous material are bonded to each other with a binder containing inorganic particles and at least one of a hydrolysate of a metal alkoxide compound and a sol of a metal oxide. In order to obtain such a bonded state, there is used a slurry adhesive containing inorganic particles, at least one of a metal alkoxide compound and a sol of a metal oxide, and a solvent.

The inorganic particles have an effect of filling in a clearance between the porous material and the heat insulating formed body to increase the adhesive strength. Further, the inorganic particles also have an effect of adhering to the insides of vacant holes of the porous material to increase the hardness of the porous material. The hardness of the porous material is an important characteristic exerting an influence on the strength of the heat insulating material, and it has become clear that the larger the degree of a rise in the hardness of the bonded porous material is, the higher the strength of the heat insulating material also becomes. Furthermore, the inorganic particles also have an effect of inhibiting penetration of the solvent contained in the adhesive into the heat insulating formed body by using them together with the sol of the metal oxide.

In order to obtain the above-mentioned effects effectively and surely, inorganic particles having an average particle size of 0.05 to 50 μm are used. More preferably, inorganic particles having an average particle size of 0.1 to 5 μm are used. The fine particles having an average particle size of less than 0.05 μm fails to sufficiently fill in the clearance between the porous material and the heat insulating formed body, resulting in a failure to obtain a sufficient adhesive strength. Further, such fine particles are available only in a coagulated state in many cases, so that there is also a problem that when the adhesive is prepared, the particles cannot be uniformly dispersed.

Further, large-sized particles having an average particle size of exceeding 50 μm disturb the contact of the porous material and the heat insulating formed body to deteriorate adhesion between them, resulting in a failure to obtain a sufficient adhesive strength. Furthermore, such large-sized particles cannot enter the vacant holes of the porous material in some cases, resulting in a failure to obtain a sufficient strength of the heat insulating material.

In addition, the kind of inorganic particles is not particularly limited as long as the particles are a substance suitable for the working temperature of the heat insulating material. However, silica, alumina, titania, aluminum silicate and iron oxide are preferred, because they are inexpensive and easily available, and further do not impair the appearance (color) of the heat insulting material. Moreover, these inorganic particles may be used as a mixture thereof.

The hydrolysate of a metal alkoxide compound and the sol of a metal oxide have a function of bonding the porous material to the heat insulating formed body, and mutually bonding the inorganic particles which have entered the clearance between them.

The alkoxide compound is represented by general formula: M-(OR)n (M: a metal atom, R: an alkyl group), and reacts with water to form the hydrolysate: M-(OH)n. Further, the hydrolysate molecules of the metal alkoxide compound are dehydration-condensed with each other, or the hydrolysate of the metal alkoxide compound is dehydration-condensed with OH groups existing on surfaces of the heat insulating formed body, the porous material and the inorganic particles to form M-O-M, thereby exhibiting a bonding effect. Accordingly, when the metal alkoxide is used, it is required that water is contained in the adhesive in an amount sufficient for hydrolysis. Further, it may be necessary to add an acid such as hydrochloric acid or sulfuric acid for accelerating hydrolysis, in some occasions.

However, when the metal alkoxide compound is used, attention should be taken to avoid excessive penetration thereof into the heat insulating formed body. This is because the heat insulating formed body into which the metal alkoxide compound has excessively penetrated will be largely deformed by heating. This phenomenon is caused by that the hydrolysate of the metal alkoxide compound forms a solvent-containing gel-like hardened material in the inside of the heat insulating formed body. The solvent contained in this hardened material evaporates by heating, which accompanies rapid shrinkage of the hardened material itself. As a result, deformation of the heat insulating formed body occurs. Accordingly, when the metal alkoxide compound is used, it is necessary to make such considerations as incorporating a material for inhibiting the penetration of the solvent into the heat insulating formed body into the adhesive in combination, or adjusting the amount of the metal alkoxide compound contained in the adhesive to such a degree that the deformation of the heat insulating formed body does not occur.

As the metal alkoxide compound, preferred is an alkoxide of silicon (for example, tetraethoxysilane). There are many alkoxide compounds other than the alkoxides of silicon. However, they are extremely expensive, and rapidly dehydration-condensed depending on the kind thereof or solid at ordinary temperature. Accordingly, they cannot be used in practice.

Further, in the invention, a condensate obtained by previously condensing several molecules of the metal alkoxide compound, and a metal alkoxide compound having an alkyl group directly bonded to a metal atom, for example, dimethyldiethoxysilane, can also be used. The former compound is advantageous in that the time required for hydrolysis of the metal alkoxide compound is shortened, and the latter compound is advantageous in that the resulting heat insulating material shows water repellency.

The sol of the metal oxide also exhibits an effect of binding the sol particles to each other, or the sol particles to the heat insulating formed body, the porous material and the inorganic particle, by OH groups existing on the surfaces of the sol particles, similarly to the hydrolysate of the metal alkoxide compound. However, the bonding strength is somewhat lower than that of the hydrolysate of the metal alkoxide compound. Accordingly, when the heat insulating material having a higher strength is required, it is desirable to use the sol of the metal oxide in combination with the metal alkoxide compound.

Further, the sol of the metal oxide exhibits an effect of inhibiting the penetration of the solvent contained in the adhesive into the heat insulating formed body by using it together with the inorganic particles. The heat insulating formed body has countless fine pores, so that when comes into contact with a liquid, it rapidly absorbs the liquid by a capillary phenomenon. Furthermore, when the liquid penetrates into the heat insulating formed body, the fine inorganic particles in the inside thereof extremely coagulate with one another. As a result, cracks occur on the surface of the heat insulating formed body, or when the liquid penetrates in large amounts, significant deformation or collapse occurs in some occasions. Accordingly, also in the invention, it is expected that the solvent contained in the adhesive penetrates into the heat insulating formed body to cause the troubles as described above. Against such an expected trouble, when the adhesive is allowed to contain the sol of the metal oxide together with the inorganic particles, the penetration of the solvent into the heat insulating formed body is significantly inhibited. In addition, this penetration inhibiting effect is also effective in the adhesive containing the metal alkoxide compound, and penetration of the metal alkoxide compound into the heat insulating formed body can also be inhibited. It is therefore preferred that the sol of the metal oxide is used together with the metal alkoxide, also for the reason described above.

As the sol of the metal oxide, there can be preferably used a sol of alumina, zirconia, titania or silica, because of its excellent binding effect, easy availability and excellent handling properties. Further, the particle size of the sol of the metal oxide is preferably 200 nm or less. Exceeding 200 nm results in a failure to obtain a sufficient binding effect, and further, results in a failure to obtain a sufficient solvent penetration inhibiting effect, even when the sol of the metal oxide is used together with the inorganic particles.

As described above, the solvent is required to contain water necessary for hydrolysis when the metal alkoxide compound is used. However, a dispersion medium of the sol of the metal oxide may contain no water. Further, a highly polar liquid such as water exerts an adverse effect on the heat insulating formed body. Accordingly, an alcohol having a polarity lower than water or a mixed solution of an alcohol and water is used as the solvent. That is, the water/alcohol mixing weight ratio is suitably from 0/100 to 70/30. Further, the alcohol may be any, as long as it can dissolve the metal alkoxide compound, and ethanol, isopropyl alcohol or the like is suitable because of its excellent safety and handling properties.

Further, an organic thickening agent is preferably added to the adhesive in order to more inhibit the troubles caused by the contact of the solvent with the heat insulating formed body. Addition of the organic thickening agent to the adhesive decreases fluidity of the solvent, so that the penetration of the solvent into the heat insulating formed body is inhibited. As the organic thickening agent, preferred is polyvinyl alcohol or an alkylcellulose. However, there is a fear of generating an abnormal odor or smoking at the time of use of the heat insulating material, so that it is desirable to adjust the amount of the organic thickening agent added to 5% by mass or less based on the total amount of the solvent.

When the heat insulating formed body and the porous material are bonded to each other, (1) a method of applying the adhesive to a bonding surface of the heat insulating formed body and (2) a method of attaching the porous material previously impregnated with the adhesive to the heat insulating formed body can be employed. However, preferred is (3) a method of placing the porous material on the heat insulating formed body, and applying the adhesive onto the porous material to allow the adhesive to penetrate into the heat insulating formed body.

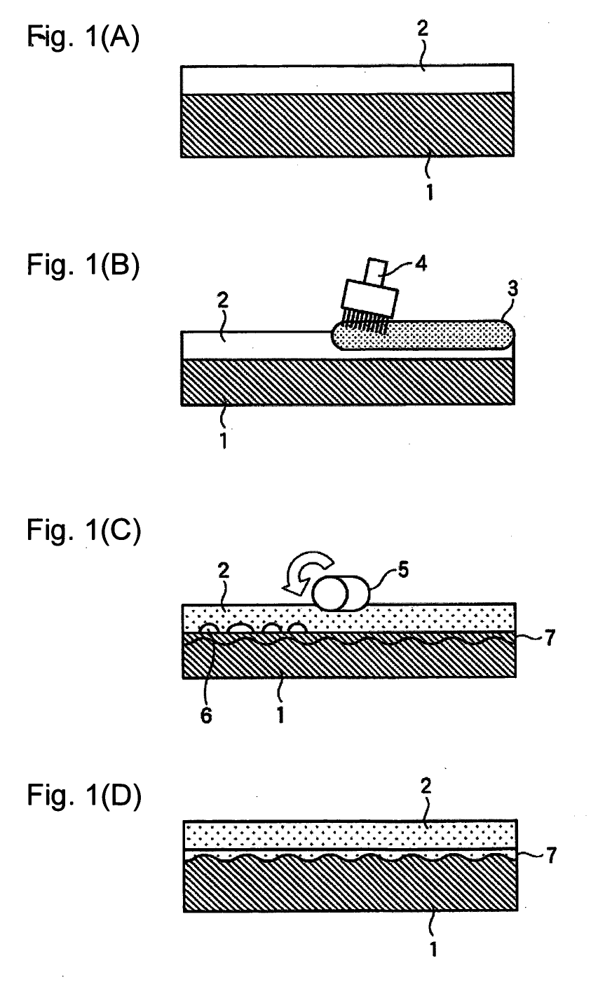

The method of (3) will be schematically shown in FIGS. 1(A) to 1(D). As shown in (A), a porous material 2 is placed on a heat insulating formed body 1, and as shown in (B), an adhesive 3 is applied onto the porous material 2. There is no limitation on a coating method of the adhesive 3, and a roll or the like can be used, as well as a brush 4 shown in the drawing. The viscosity of the adhesive 3 is adjusted depending on the coating method. Further, the amount thereof applied is appropriately set depending on the density or form of the heat insulating formed body 1, the material or thickness of the porous material 2, the area of the portion to be bonded, or the like. Then, the adhesive 3 applied moves toward the heat insulating formed body 1 through the vacant holes of the porous material 2, and further penetrates into a surface layer portion of the heat insulating formed body 1 as shown by the numeral 7. Then, as shown in (C), a roller 5 or the like is pressed onto the porous material while the adhesive 3 is not cured, thereby deaerating air 6 mixed in the heat insulating formed body 1 and the porous material 2 or existing at the interface of the heat insulating formed body 1 and the porous material 2. Thereafter, as shown in (D), the solvent is removed by drying, whereby the heat insulating formed body 1 and the porous material 2 are completely bonded to each other with the binder containing the inorganic particles and at least one of the hydrolysate of the metal alkoxide compound and the sol of the metal oxide. Meanwhile, there is no limitation on the drying method, and both of drying by heating and air seasoning (air drying) may be used.

According to the above-mentioned method of (3), adjustment of the bonding position of the porous material 2, and bonding on a curved surface of the heat insulating formed body 1 are easy, and further, lack of coating and excessive coating of the adhesive 3 can also be prevented. This method is therefore suitable. In contrast, according to the method of (1), the amount of the adhesive which penetrates into the porous material 2 becomes insufficient in many cases, so that there is a fear of failing to obtain a sufficient hardness increasing effect. Further, according to the method of (2), the amount of the adhesive tends to become excessive.

### EXAMPLES

The present invention will be illustrated in greater detail with reference to the following examples and comparative examples, but the invention should not be construed as being limited thereto.

### Example 1

Seventy-five parts by weight of fine silica particle having a primary particle size of 0.012 μm and a BET specific surface area of 200 m²/g, 5 parts by weight of silica fiber having an average diameter of 10 μm and an average fiber length of 6 mm and 20 parts by weight of silicon carbide were mixed to a homogeneous mixture. This mixture was press-formed to obtain a heat insulating formed body of 500 mm×500 mm×25 mm having a density of 240 kg/m³ and a thermal conductivity of 0.025 W/m·K (100° C.).

Further, there was prepared a slurry adhesive comprising 10 pars by weight of silica particles having an average particle size of 0.5 μm, 10 parts by weight of a pentamer of tetraethoxysilane, 10 parts by weight of a silica sol using methanol as a dispersion medium and having a solid content of 30% by mass and a particle size of 20 nm, 53 parts by weight of ethanol and 17 parts by weight of water. Meanwhile, this adhesive contains a certain amount of hydrochloric acid in order to accelerate hydrolysis, and has been allowed to stand with stirring for about 12 hours.

Then, a papermaking product (thickness: 1 mm, weight per unit area: 250 g/m²) containing aluminum silicate fiber as a main component was placed on a front surface of the above-mentioned heat insulating formed body, and the adhesive was applied onto the papermaking product to bond it to the heat insulating formed body. Thereafter, a papermaking product containing aluminum silicate fiber as a main component was also bonded to a back side of the heat insulating formed body in a similar manner as described above.

Then, the heat insulating formed body with the papermaking products bonded to the front and back sides was allowed to stand under circumstances of room temperature all day and night to remove the solvent of the adhesive (dried naturally), thereby obtaining a heat insulating material.

From the resulting heat insulating material, a test piece of 100 mm×30 mm was cut out, and a three-point bending test was performed at a support-to-support distance of 80 mm. As a result, it broke at a load of 50 N. Further, the front and back sides of the resulting heat insulating material were completely covered with the paper, so that no adhesion of fine silica particles was observed by touch. Furthermore, the heat insulating material was heated at 800° C. for 3 hours. As a result, troubles such as separation and breakage of the bonded papermaking product were not observed.

### Example 2

A heat insulating material was prepared in the same formulation as in Example 1 with the exception that a glass cloth having a thickness of 0.2 mm and a weight per unit area of 200 g/m² was used in place of the papermaking product containing aluminum silicate fiber as a main component.

Then, the three-point bending test of the resulting heat insulating material was performed under the same conditions as in Example 1. As a result, it broke at a load of 73 N. Further, the front and back sides of the resulting heat insulating material were completely covered with the glass cloth, so that no adhesion of fine silica particles was observed by touch. Furthermore, the heat insulating material was heated at 500° C. for 3 hours. As a result, troubles such as separation and breakage of the bonded glass cloth were not observed. However, when it was heated at 800° C. for 3 hours, the glass cloth shrunk by melting to cause separation, and deformation of the heat insulating formed body associated therewith was observed.

### Example 3

A heat insulating material was prepared in the same formulation as in Example 1 with the exception that no silica sol was added and that 8 parts by weight of ethanol and 0.4 part by weight of an alkylcellulose were added in place thereof, in the preparation of the adhesive.

Then, the three-point bending test of the resulting heat insulating material was performed under the same conditions as in Example 1. As a result, it broke at a load of 50 N. Further, the front and back sides of the resulting heat insulating material were completely covered with the papermaking product, so that no adhesion of fine silica particles was observed by touch. Furthermore, the heat insulating material was heated at 800° C. for 3 hours. As a result, troubles such as separation and breakage of the bonded papermaking product were not observed.

### Example 4

A heat insulating material was prepared in the same formulation as in Example 1 with the exception that no tetraethoxysilane was added and that 8 parts by weight of ethanol was added in place thereof, in the preparation of the adhesive.

Then, the three-point bending test of the resulting heat insulating material was performed under the same conditions as in Example 1. As a result, it broke at a load of 35 N. Further, the front and back sides of the resulting heat insulating material were completely covered with the papermaking product, so that no adhesion of fine silica particles was observed by touch. Furthermore, the heat insulating material was heated at 800° C. for 3 hours. As a result, troubles such as separation and breakage of the bonded papermaking product were not observed.

### Example 5

A heat insulating material was prepared in the same formulation as in Example 1 with the exception that the average particle size of the silica particles was changed to 30 μm in the preparation of the adhesive.

Then, the three-point bending test of the resulting heat insulating material was performed under the same conditions as in Example 1. As a result, it broke at a load of 42 N. Further, the front and back sides of the resulting heat insulating material were completely covered with the papermaking product, so that no adhesion of fine silica particles was observed by touch. Furthermore, the heat insulating material was heated at 800° C. for 3 hours. As a result, troubles such as separation and breakage of the bonded papermaking product were not observed.

### Comparative Example 1

From a heat insulating formed body prepared in the same manner as in Example 1, a test piece of 100 mm×30 mm was cut out, and the three-point bending test was performed at a support-to-support distance of 80 mm. As a result, it broke at a load of 23 N.

### Comparative Example 2

A heat insulating material was prepared in the same formulation as in Example 1 with the exception that no silica particles were added in the preparation of the adhesive.

Then, the three-point bending test of the resulting heat insulating material was performed under the same conditions as in Example 1. As a result, it broke at a load of 27 N. Further, the heat insulating material was heated at 800° C. for 3 hours. As a result, the heat insulating formed body was largely deformed in the vicinity of the bonding surface, and significant separation of the papermaking product was observed.

### Comparative Example 3

A heat insulating material was prepared in the same formulation as in Example 1 with the exception that no silica particles and no silica sol were added and that 8 parts by weight of ethanol was added in place thereof, in the preparation of the adhesive.

Then, the three-point bending test of the resulting heat insulating material was performed under the same conditions as in Example 1. As a result, it broke at a load of 24 N. Further, the heat insulating material was heated at 800° C. for 3 hours. As a result, the heat insulating formed body was largely deformed in the vicinity of a bonding surface, and significant separation of the paper was observed.

### Comparative Example 4

A heat insulating material was prepared in the same formulation as in Example 1 with the exception that no silica particles and no tetraethoxysilane were added and that 8 parts by weight of ethanol was added in place thereof, in the preparation of the adhesive.

In the resulting heat insulating material, adhesion of the papermaking product was not sufficiently performed, so that when the heat insulating material was carried, the papermaking product was completely separated.

### Comparative Example 5

A heat insulating material was prepared in the same formulation as in Example 1 with the exception that the amount of ethanol was changed to 5 parts by weight and that the amount of water was changed to 77 parts, in the preparation of the adhesive.

In the resulting heat insulating material, depression-like deformation was observed on a surface thereof.

While the present invention has been described in detail and with reference to specific embodiments thereof, it will be apparent to one skilled in the art that various changes and modifications can be made therein without departing from the spirit and scope thereof.

This application is based on Japanese Patent Application No. 2007-033484 filed Feb. 14, 2007, and the contents thereof are herein incorporated by reference.

1. A heat insulating material comprising a heat insulating formed body and a sheet-shaped porous material bonded to at least a part of the surface of the heat insulating formed body with a binder, wherein the binder comprises:
inorganic particles having an average particle size of 0.05 to 50 μm; and
at least one of a hydrolysate of a metal alkoxide compound and a sol of a metal oxide.

2. The heat insulating material according to claim 1, wherein the heat insulating formed body contains fine silica particles, fine alumina particles, fine aluminum silicate particles or a mixture thereof, which has a BET specific surface area of 15 to 500 m²/g and a primary particle size of 0.003 to 1 μm.

3. The heat insulating material according to claim 1, wherein the heat insulating formed body contains at least one of a fibrous material and an opacifying material.

4. The heat insulating material according to claim 1, wherein the porous material is a papermaking product, a woven fabric or a nonwoven fabric, which contains an inorganic fibrous material.

5. A method for producing a heat insulating material which comprises bonding a heat insulating formed body and a sheet-shaped porous material to each other with a slurry adhesive containing:
inorganic particles having an average particle size of 0.05 to 50 μm;
at least one of a metal alkoxide compound and a sol of a metal oxide; and
a solvent.

6. The method for producing a heat insulating material according to claim 5, wherein the method comprises:
superimposing the heat insulating formed body and the porous material one on the other;
applying the adhesive onto the porous material to allow the adhesive to penetrate thereinto; and
drying.

7. The method for producing a heat insulating material according to claim 5, wherein the solvent is a mixed solution of water and an alcohol having a water/alcohol weight ratio ranging from 0/100 to 70/30.

8. The method for producing a heat insulating material according to claim 5, wherein the adhesive contains an organic thickening agent.
